(19) United States
(12) Patent Application Publication
(10) Pub. No.: US 2024/0291224 A1
(43) Pub. Date: Aug. 29, 2024

(54) Pluggable L-band Optical Amplifier

(71) Applicant: II-VI Photonics, Inc., Fuzhou (CN)

(72) Inventors: Xiangfei Wang, Fuzhou (CN); Wenjing Yan, Fuzhou (CN); Jianyu Zhang, Fuzhou (CN); Jun Han, Shanghai (CN)

(21) Appl. No.: 18/121,406

(22) Filed: Mar. 14, 2023

(30) Foreign Application Priority Data
Feb. 28, 2023 (CN) 2023101804127

(51) Int. Cl. H01S 3/10; H01S 3/067; H01S 3/094

(52) U.S. Cl. CPC H01S 3/10015; H01S 3/06704; H01S 3/094003

(57) ABSTRACT

An optical L-band amplifier device, which may include a pluggable housing, a two-stage fiber amplification optical path with ultra-high absorption fiber. The device may include an IWDM and a fiber coupling that are protected by coating. The device may be housed in a multi-source agreement (MSA) compliant housing.

### CROSS-REFERENCE TO RELATED APPLICATION

This patent application claims priority to and the benefit from Chinese Patent application CN2023101 8041 27 filed Feb. 28, 2023 at the Chinese National Intellectual Property Administration (CNIPA). The above application is incorporated by reference herein.

### TECHNICAL FIELD

The present disclosure generally relates to a pluggable L-band optical amplifier.

### BACKGROUND

Aspects of the present disclosure relate to a pluggable L-band optical amplifier. Various issues may exist with conventional solutions for optical fiber arrays. In this regard, conventional systems and methods for optical fiber arrays may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

### BRIEF SUMMARY OF THE DISCLOSURE

Shown in and/or described in connection with at least one of the figures, and set forth more completely in the claims are a pluggable L-band optical amplifier.

These and other advantages, aspects and novel features of the present disclosure, as well as details of illustrated embodiments thereof, will be more fully understood from the following description and drawings.

### BRIEF DESCRIPTION OF THE DRAWINGS

The various features and advantages of the present disclosure may be more readily understood with reference to the following detailed description taken in conjunction with the accompanying drawings, wherein like reference numerals designate like structural elements.

FIG. 1 provides a diagram of an exemplary communication process using pluggable L-band optical amplifiers.

FIG. 2 provides an exemplary drawing of a pluggable L-band optical amplifier.

FIG. 3 provides an exemplary explosion drawing of a pluggable L-band optical amplifier.

FIG. 3A shows an exemplary mechanical layout of a pluggable L-band optical amplifier.

FIG. 4 provides an exemplary cross-section drawing of a pluggable L-band optical amplifier.

FIG. 4A illustrates an exemplary mounting for a pump on a PCBA.

FIG. 4B illustrates an exemplary FMR 210 with Fiber Clips 235.

FIG. 5 provides an exemplary optical path schematic of a pluggable L-band optical amplifier.

FIG. 6 provides an exemplary drawing of a fiber arrangement of a pluggable L-band optical amplifier.

FIG. 7 shows an exemplary IWDM.

FIG. 8A shows an exemplary absorption of erbium-doped fiber as a function of wavelength.

FIG. 8B shows an exemplary absorption of erbium-doped fiber as a function of wavelength.

FIG. 8C shows an exemplary emission of erbium-doped fiber as a function of wavelength.

FIG. 8D illustrates total output power of a pluggable L-band amplifier.

FIG. 8E illustrates total signal output power of a pluggable L-band amplifier.

FIG. 8F illustrates a noise figure of a pluggable L-band amplifier.

FIG. 8G illustrates a gain flatness for a pluggable L-band amplifier.

FIG. 8H illustrates a signal power to ASE power ratio for a pluggable L-band amplifier.

### DESCRIPTION

The following discussion provides various examples of a pluggable L-band optical amplifier. Such examples are non-limiting, and the scope of the appended claims should not be limited to the particular examples disclosed. In the following discussion, the terms “example” and “e.g.” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

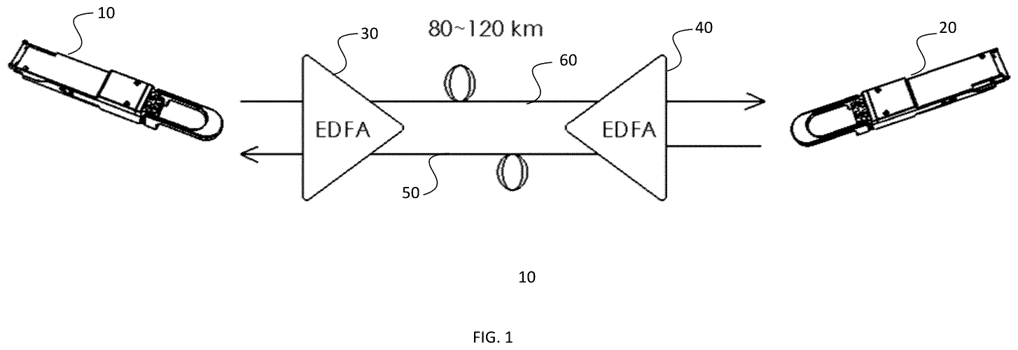

FIG. 1 shows a diagram of an exemplary communication process. There are shown QSFP L-band amplifiers 10, 20 communicatively coupled to erbium-doped fiber amplifier (EDFA) 30, 40. The EDFA 30, 40 may be communicatively coupled to lengths of fiber 50, 60.

The amplifiers 10, 20 may be part of a communications system and may be operable to transmit and/or receive optical signals and electrical signals and amplify such optical and/or electrical signals. The optical signals may be in the L-band, which may range from approximately 1565 nm to approximately 1625 nm. The amplifiers 10, 20 may be in a Quad Small Form-factor Pluggable (QSFP) module format.

EDFA 30, 40 may be operable to amplify optical signals. EDFA 30, 40 may be operable to compensate for the loss of an optical fiber in long-distance optical communication. EDFA 30, 40 may be operable to amplify multiple optical signals simultaneously and may be suitable to be combined with WDM technology. There are further shown fiber lengths 50 and 60, enabled to provide fiber optical communications over longer distances.

FIG. 1 may illustrate an exemplary communication system where amplifiers 10, 20 may comprise the EDFA 30, 40 to transmit/receive optical signals via fiber 50 and 60. Similarly, EDFA 40 may be coupled to fibers 50, 60 and transmit/receive optical signals. Amplifier 20 may comprise EDFA 40 to transmit and receive optical signals via fibers 50, 60. The optical signals transmitted and/or received may be e.g., communication signals. FIG. 1 may illustrate fiber optic communications in data centers, core networks, access and CATV networks, for example. The pluggable L-band amplifiers 10, 20 may include a preamp optical amplifier or a booster optical amplifier, each of which may include an erbium-doped fiber amplifier (EDFA). In some embodiments, the pluggable amplifiers 10, 20 may have a host interface (not shown) that supports or is adapted from a Common Management Interface Specific (CMIS) Rev 4.0 (or other revisions) or multi-source agreement (MSA) SFF-8636. Such a host interface may implement register mapping on a serial interface common to transceiver or transponder shelves for digital diagnostics and management purposes.

Each of the preamp and booster optical amplifiers may use an operational wavelength range in an optical spectrum of the EDFA that has a relatively flat gain spectrum. Some embodiments may apply to two-stage amplifiers to achieve a target high output power in the L-band. Some embodiments may improve system optical signal-to-noise ratio (OSNR). Tunable optical filter (MEMS TOF/MTOF) may be applied after EDFAs, as will be shown with reference to other figures. Some embodiments may apply a variable optical attenuator (VOA) to adjust output power.

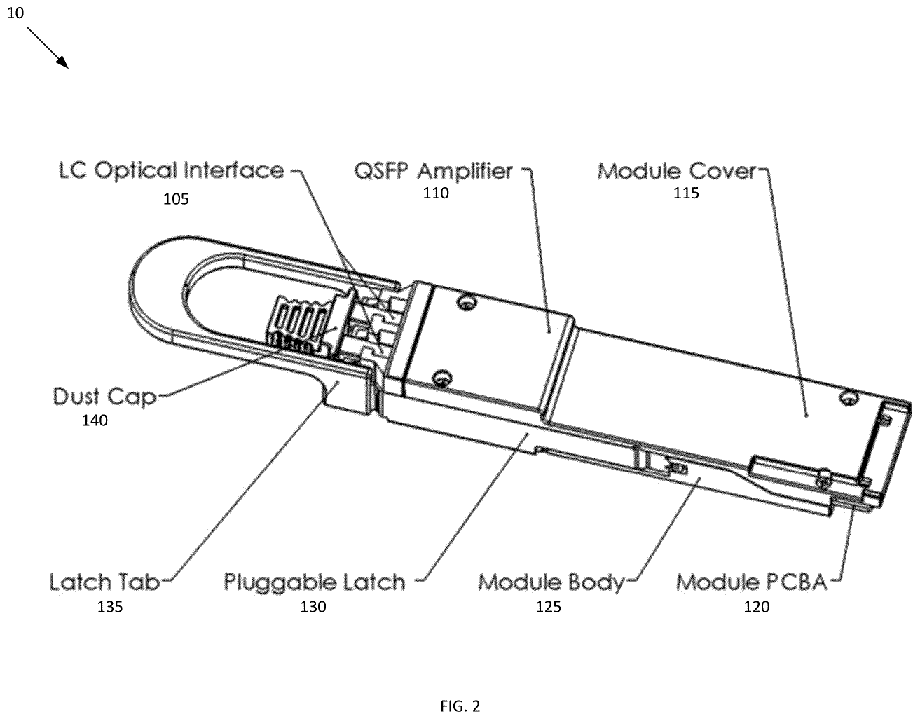

FIG. 2 shows an exemplary QSFP L-band amplifier. There are shown a QSFP L-band amplifier 10 comprising an LC optical interface 105, QSFP amplifier 110, module cover (housing cover) 115, module PCBA 120, module body (housing body) 125, pluggable latch 130, latch tab 135, and dust cap 140. The amplifier 10 may be housed in a QSFP package, which may be pluggable and/or hot-pluggable. In accordance with various embodiments of the disclosure, packaging may be compatible with a pluggable multi-source agreement (MSA) compliant package structure. The package structure may additionally be OSFP, QSFP-DD, QSFP-like and may be enabled to plug directly into transceiver cages/slots on routers, switches, or other transmission chassis used in a datacenter, for example. Other compatible package structures may be QSFP+, QSFP28 4X, or multivendor protocol SFF-8661.

The LC optical interface 105 may be a small form factor connector, which may join LC fibers when a connection may be required. The LC optical interface 105 may be an optical port to couple optical fiber systems. The LC optical interface 105 may be protected with a dust cap 140, which may protect the optical port from contamination.

The QSFP amplifier 110 may be operable to amplify one or more input signals and provide one or more amplified output signals. The various components of amplifier 10 may be housed in the module body 125. The module cover 115 may protect circuitry of the amplifier 10 from environmental factors. The pluggable latch 130 may be used to unlock/lock the housing when plugging it in, or unplugging it. Latch tab 135 may be used to hold the module body 125 when pushing in or pulling out the amplifier 10 in use. There is shown a Module Printed Circuit Board Assembly (PCBA) 120, which may comprise various circuitry and/or components. The PCBA 120 may be compatible with the multi-vendor protocol MSA SFF-8679. In some instances, the PCBA 120 may comprise an electrical interface comprising e.g., a gold-pin interface.

End users of an amplifier 10 may connect optical input and output signals through the dual ports of the LC Optical Interface 105. Power supply, management and control of electrical signals may be coupled to the amplifier 10 through connector pins on the PCBA 120 (not shown), at the module end opposite to the LC Optical Interface 105.

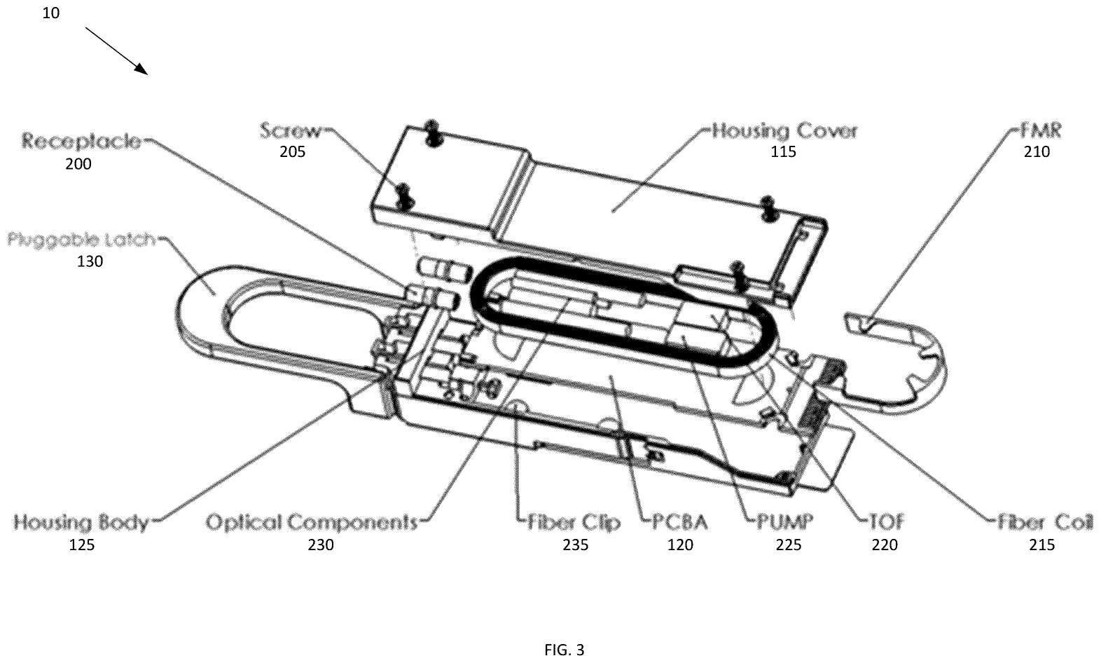

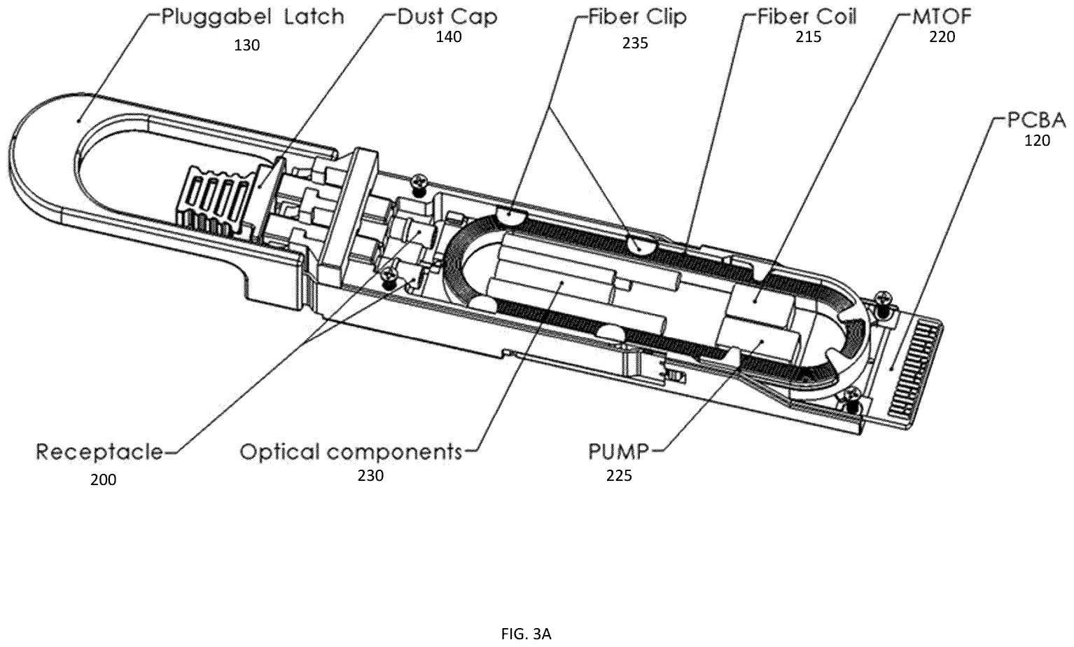

FIG. 3 shows an exemplary explosion view of a pluggable L-band optical amplifier 10. There are shown a pluggable latch 130, a housing body 115 substantially similar to a module cover 115, a housing body 125 substantially similar to a module body 125. There is further shown a PCBA 120. There are further shown a receptacle 200, screws 205, FMR 210, fiber coil 215, TOF 220, pump 225, fiber clip 235, and optical components 230.

The receptacle 200 may be operable to receive an input or output fiber. The receptacle 200 may be comprised of an LC connector. The screws 205 may be operable to attach the housing cover 115 to the housing body 125. The screws 205 may be operable to keep the various components of amplifier 10 in place and assembled.

The FMR 210 maybe a fiber manage ring, which may be fixed to e.g., the PCBA 120 or the housing body 125. The FMR 210 may be enabled to protect the optical fiber, and bind and guide the optical fiber. The FMR 210 may be attached to the PCBA 120 to prevents the optical fiber from interfering with the electrical interface.

The fiber coil 215 may be a length of fiber. The fiber may be erbium-doped fiber. In accordance with various embodiments of the disclosure, the fiber coil 215 may be wound in an elliptical shape to fit the size of the packaging, for example a QSFP. The length of the fiber may range from a few meters to several dozen meters. The length of the fiber may be selected in accordance with power output and amplification gain requirements. The fiber coil 215 may be held in place by FMR 210, and/or the fiber clips 235.

The optical fiber of the fiber coil 215 may adopt a small coating diameter fiber, such as, for example, a 135-micrometer diameter coated optical fiber instead of larger-diameter coated optical fiber. A smaller diameter of the fiber used in fiber coil 215 may reduce the volume required in the amplifier module 10, enabling smaller form factors. The erbium-doped fiber may be an ultra-high absorption erbium-doped fiber, for example, with a coating diameter of 135 micrometer and a cladding diameter of 80 micrometer, but may not be so limited. Ultra-high absorption erbium-doped fiber may enable significantly higher absorption per meter of fiber length. In this case, much shorter fiber length may be employed compared to lower absorption conventional fiber. Using shorter fiber lengths may permit smaller form factors for the amplifier 10. For example, absorption of greater than 40 dB per meter at a wavelength of 1530 nm may be ultra-high absorption. In accordance with various embodiments of the disclosure, the absorption may be 55 db or greater per meter at a wavelength of 1530 nm. More conventional erbium-doped fiber may provide absorption of 15-25 dB per meter at a wavelength of 1530 nm.

There is further shown a TOF 220, a tunable optical filter. A TOF 220 may be a filter with a tunable wavelength. The TOF 220 may be a MEMS (microelectromechanical) tunable optical filter (MTOF). The TOF 220 may be operable to reduce amplified spontaneous emissions (ASE), which is light produced by spontaneous emission that may have been optically amplified by the process of stimulated emission in a gain medium. It may be inherent in the field of random lasers. By reducing ASE, the TOF 220 may improve an (optical) signal-to-noise ratio (OSNR).

The pump 225 may be a laser light source. The pump 225 may be operable to achieve a low noise, high-power optical amplification in a small-sized system. In accordance with various embodiments of the disclosure, the pump 225 may be operable in a wide range of temperatures, e.g., from −40° C. to 85° C. The pump may be cooled or uncooled. In some instances, the power consumption of the pump 225 may be very low, and may greatly reduce the heat and power consumption of the whole optical amplifier system 10, thereby also reducing the difficulty of heat dissipation from the system. In accordance with various embodiments of the disclosure, the pump 225 may be a Bragg grating design that may provide stable laser wavelength output over a large operating temperature range. The laser center wavelength may be tunable to meet the design requirements of different optical amplifiers. The pump 225 may be enabled to operate with 80 micrometer fiber, or 125 micrometer fibers. The use of 80 micrometer fiber (cladding diameter) may be advantageous when a smaller platform may be desired, such as QSFP, QSFP-DD, OSFP, and other standardized housings. The pump 225 may also meet telecom industry standard requirements, e.g., Telcordia GR-468-CORE. In some instances, the pump 225 may comprise two pumps according to design needs. For example, this may be desirable when a primary and a secondary amplification may be desired. The pump 225 may be a 980 nm laser, for example. The pump 225 may be used as the energy source of the fiber coil 215, which may be the active element of the EDFA.

Fiber clips 235 may be used to keep fiber in the desired position in the housing body 125. The optical components 230 may be various optical and sometimes electrical or mechanical components desirable to operate an optical L-band amplifier 10. Specifically, such optical components 230 may be small for use in small form-factor pluggable packages such as e.g., QSFP.

FIG. 3A shows an exemplary mechanical layout of a pluggable L-band optical amplifier. The same reference numerals in denote the same elements as in previous figures. FIG. 3A illustrates an L-band optical amplifier as shown in FIG. 3 without the housing cover, and in assembled form.

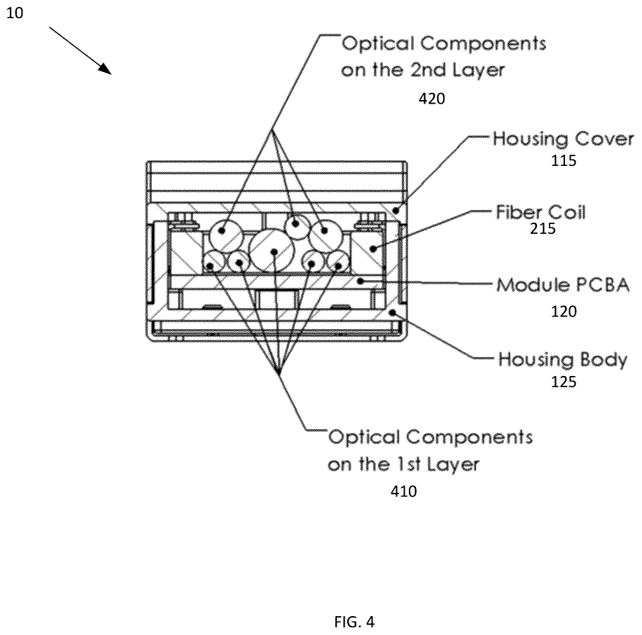

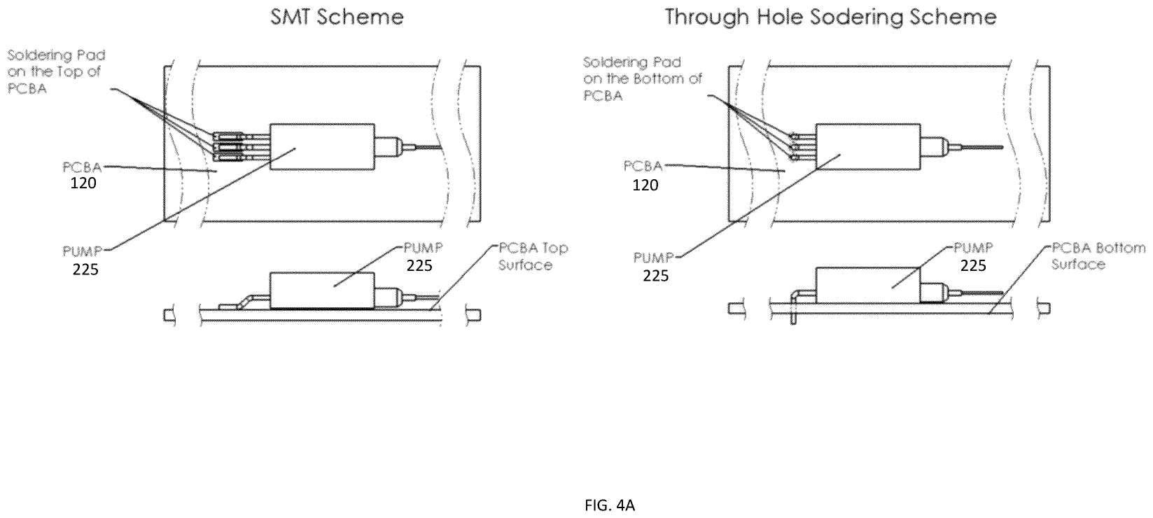

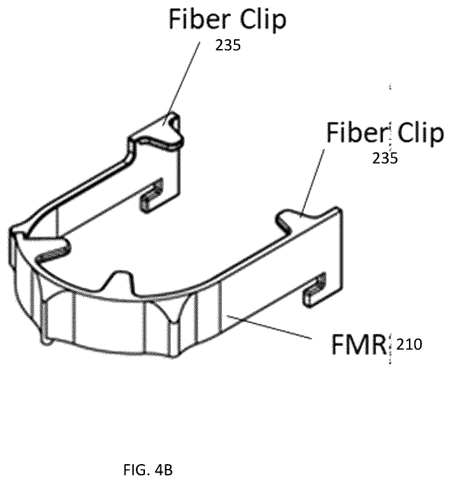

FIG. 4 shows an exemplary cross-section of the pluggable L-band fiber amplifier module 10. There are shown a housing cover 115, a fiber coil 215, a module PCBA 120, and a housing body 125. There are further shown optical components on a first layer 410, and on a second layer 420. To better utilize the space available in the package of the amplifier module 10, a number of optical components, especially those using lengths of fiber, may be arranged in two layers 410, 420. For example, on a first layer 410 there may be one or more detector taps, e.g., Tap photodetectors, and/or one or more variable optical attenuators (VOA). On a second layer 420, there may be one or more pump splitters, isolators or isolating wavelength division multiplexers (IWDM). By suitably arranging components of varying diameter on a first layer 410 and a second layer 420, the space within a housing, e.g., a QSFP module, may be utilized more efficiently.

FIG. 4A illustrates an exemplary mounting for a pump on a PCBA. The same reference numerals may refer to similar elements in previous figures. A pump 225 may be mounted on a PCBA 120 using SMT surface mounting. The pump 225 may comprise 3 pins, for example. The pins of the pump 205 may thus be mounted on a top of the PCBA 120. Alternatively, the pump 225 may be mounted on the PCBA 120 using a through hole soldering method, therefore soldering the pump 225 to the PCBA 120 on the bottom surface of the PCBA 120.

FIG. 4B illustrates an exemplary FMR 210 with Fiber Clips 235. The same reference numerals may refer to similar elements in other figures. FIG. 4B illustrates an FMR 210 in detail with Fiber Clips 235 operable to maintain fibers in place, as described with reference to FIG. 3.

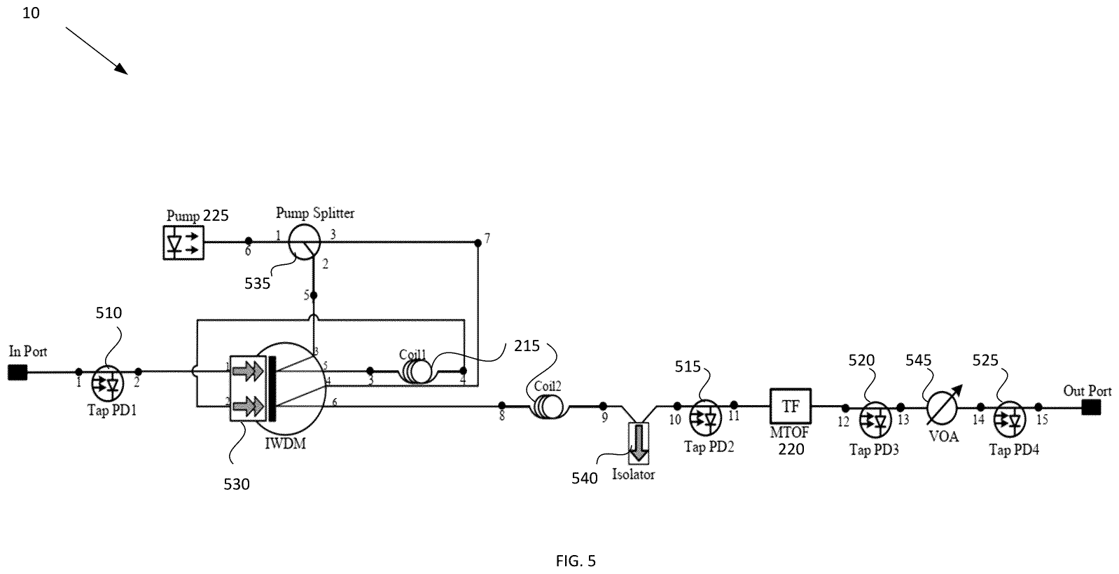

FIG. 5 shows an exemplary optical path schematic of a pluggable L-band fiber amplifier module 10. There are shown an input port and an output port. There are further shown a pump 225, fiber coils 215, and a TOF 220. There are also shown Tap PD1 510, Tap PD2 515, Tap PD3 520, and Tap PD4 525. There is shown a IWDM 530, pump splitter 535, and isolator 540, and variable optical attenuator 545. The components shown in FIG. 5 may be coupled together as illustrated, in accordance with various embodiments of the disclosure.

The pump splitter 535 may be operable to split the output signal of pump 225 at its input (1) into two output signals (2, 3).

The in port and the out port may be, for example, receptacles 200 and/or LC optical interfaces 105. Tap PD 510, 515, 520, 525 may be operable to observe signals carried on a length of fiber, for example using a photodetector. Some embodiments may apply Tap PDs before and after VOA to enable a loopback control.

The IWDM 530 may be operable to combine a high-power multimode pump and a single mode signal to a dual cloud pump signal fiber output, thereby providing multiplexing and isolation in one small package. The IWDM 530 illustrated may be enabled to provide two isolators and two WDMs. Ports 1 and 2 may be for signal lights inputs. Ports 3 and 4 may be pump light inputs. Ports 5 and 6 may feed coil 1 and coil 2 of the fiber coil 215. This specific structure may be desirable for two-stage amplification using two coils.

The fiber coil 215 may be illustrated in a two-coil embodiment, comprising coil 1 and coil 2. Such an arrangement may be referred to as a two-stage amplification optical path. Because of the absorption and radiation characteristics of erbium-doped fiber, two-stage amplification, longer erbium fiber, and higher pump power may be desirable to achieve greater output power of the amplifier 10. The power of the module 10 may be controlled to meet the power consumption requirements of e.g., high-density switches, routers and other optical fiber amplification modules. The optical isolator 540 may be a component which allows the transmission of light in only one direction, and may prevent unwanted feedback. The VOA 545 may enable variable optical attenuation.

The optical fiber connections between the optical device, the erbium-doped fiber, and the optical ports, may be coupled by a welding method for the splicing. The welding method may use coating technology instead of more common heat shrink tubing. The main advantage of using a coating instead of a heat shrink tube, is that the connections (splicings) may be protected by the coating without adding much diameter to the fiber. In other words, while a heat shrink tube significantly increases the diameter of the connection, the coating may barely increase the diameter. Correspondingly, the fibers protected by coating may take up much less volume in the module than a fiber protected by heat shrink tube, permitting a smaller form factor. In accordance with various embodiments of the disclosure, the coating of the splicings/connections may be applied using glue and heat. Such coated optical fiber splicing points may withstand a 150 kpsi proof test, for example, and comply with various telecommunication standards.

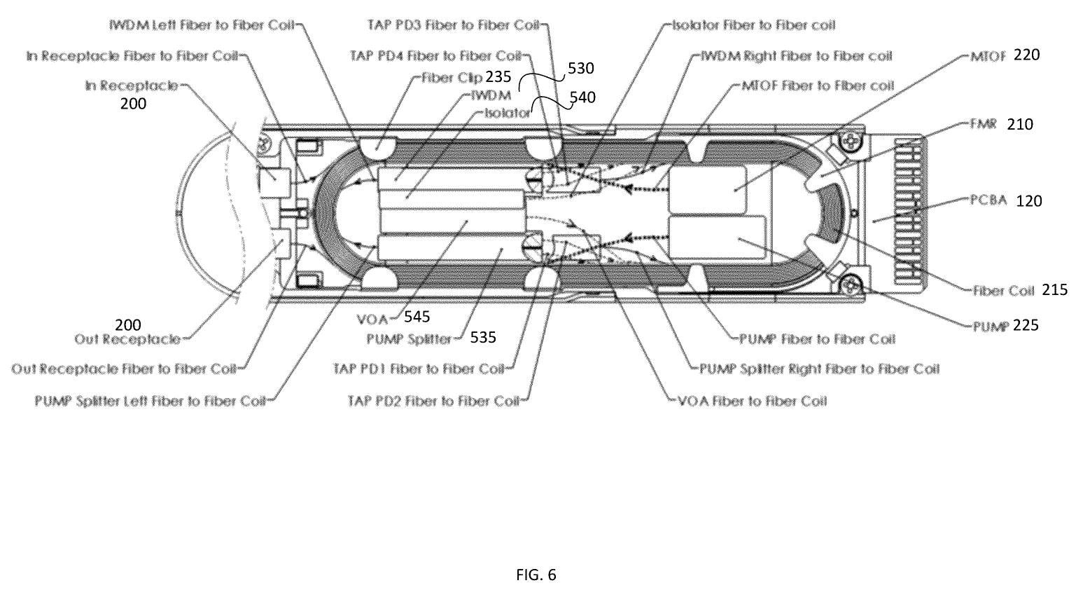

FIG. 6 shows an exemplary arrangement of a pluggable L-band fiber amplifier module 10 similar to the optical path schematic of FIG. 5. Elements shown in FIG. 6 may be substantially similar to those same numbered elements in earlier figures. A number of fiber connections are additionally labeled. The fiber connections shown in dotted line may be below other passive elements. In accordance with various embodiments of the disclosure, the radius of fiber coil 215 may be larger than 5 mm. That IWDM 530 may be placed above tap PD3 and tap PD4. Similarly, the pump splitter 535 may be placed above tap PD1 and tap PD2. The isolator 540 may be located below other passive devices.

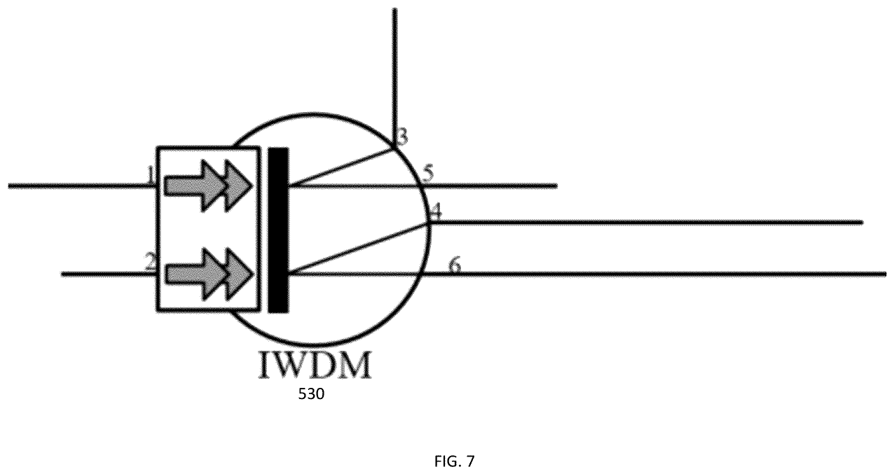

FIG. 7 shows an exemplary IWDM. The same reference numerals refer to similar elements in other figures. The IWDM 530 illustrated may be enabled to provide two isolators and two WDMs. Ports 1 and 2 may be for signal lights inputs. Ports 3 and 4 may be pump light inputs. Ports 5 and 6 may feed coil 1 and coil 2 of the fiber coil 215. This specific structure may be desirable for two-stage amplification using two coils. The device may comprise a dual fiber head, collimating lens, two isolator cores, a filter, and a quad fiber head. Its function may be similar to two IWDMs integrated into a cylindrical device for two-stage amplification. The device may be referred to as a four-in-one device as it may comprise the functions of two isolators and two WDMs. Such a setup may reduce the device volume, reduce the number of fiber connections, and may require less fiber length. The IWDM 530 may be communicatively coupled as illustrated in FIG. 6.

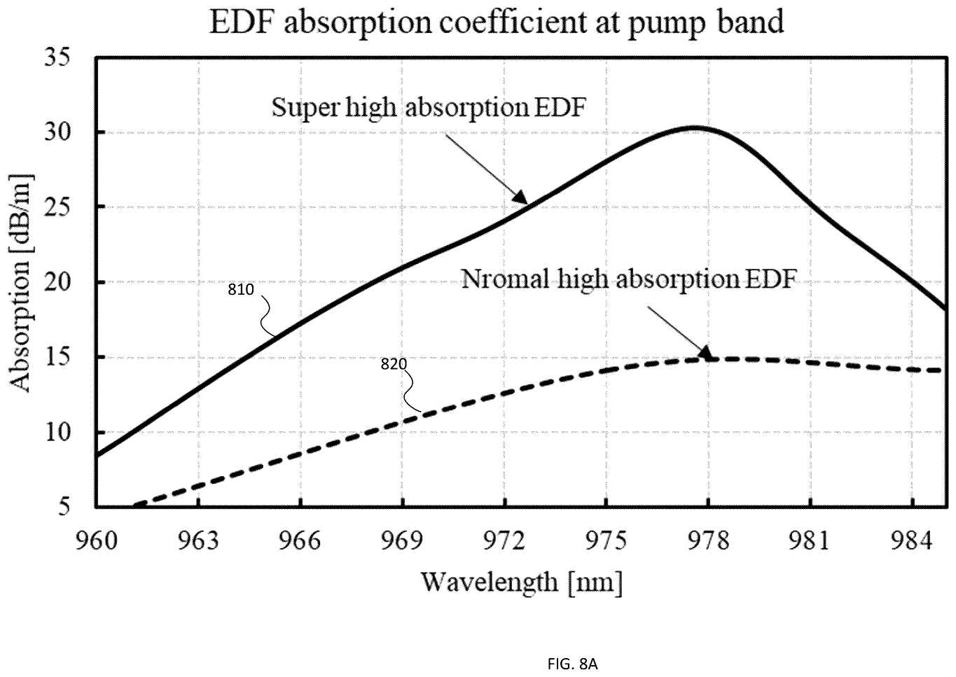

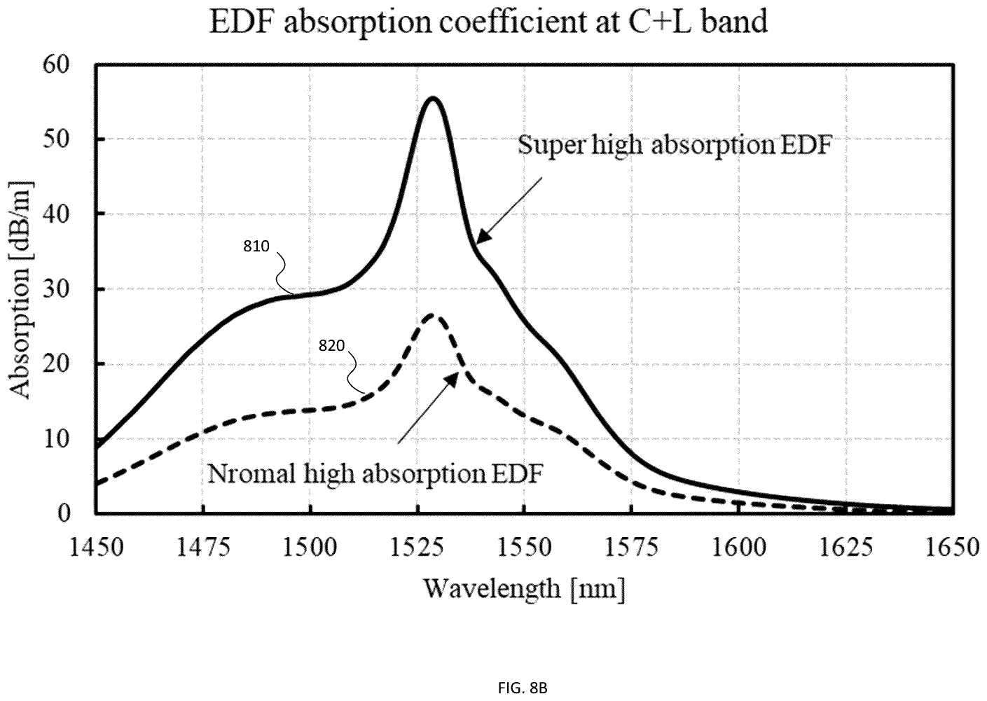

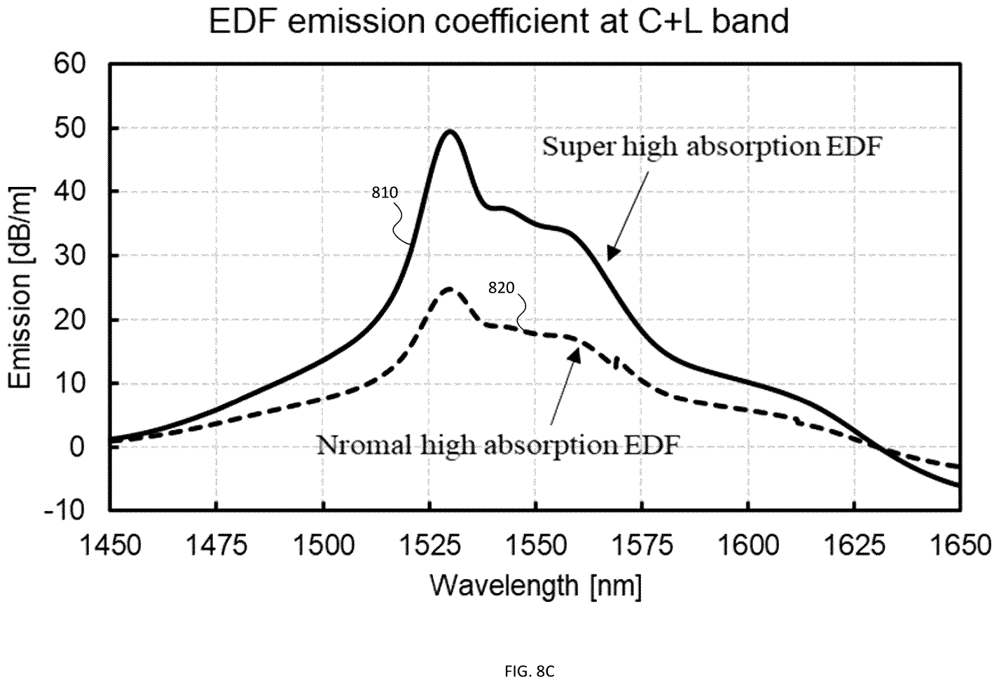

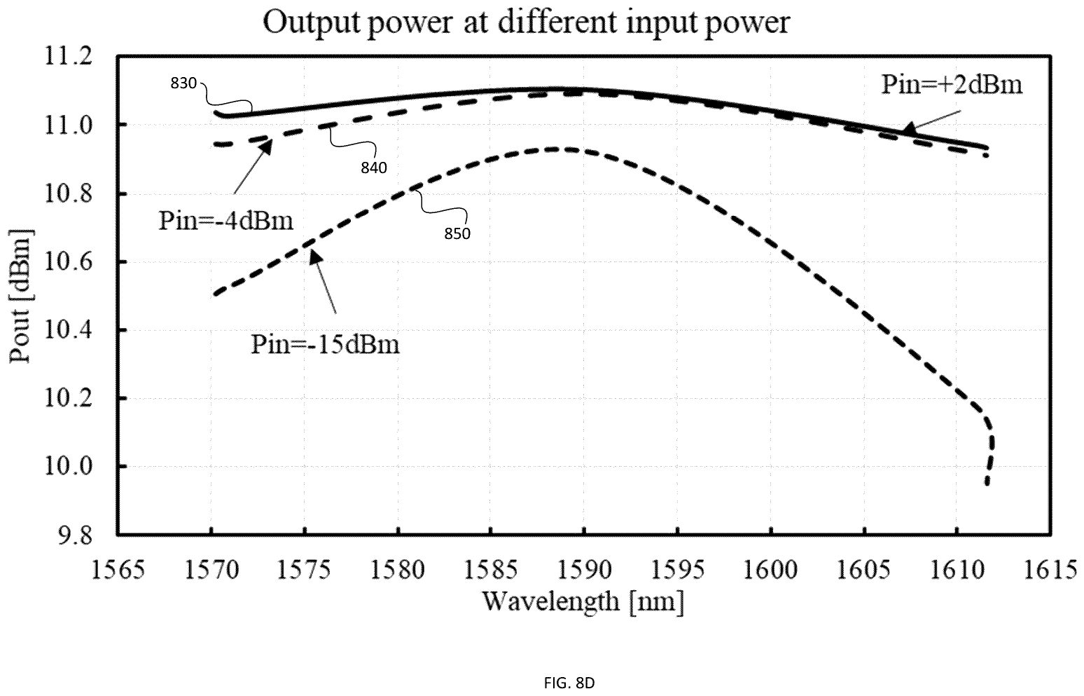

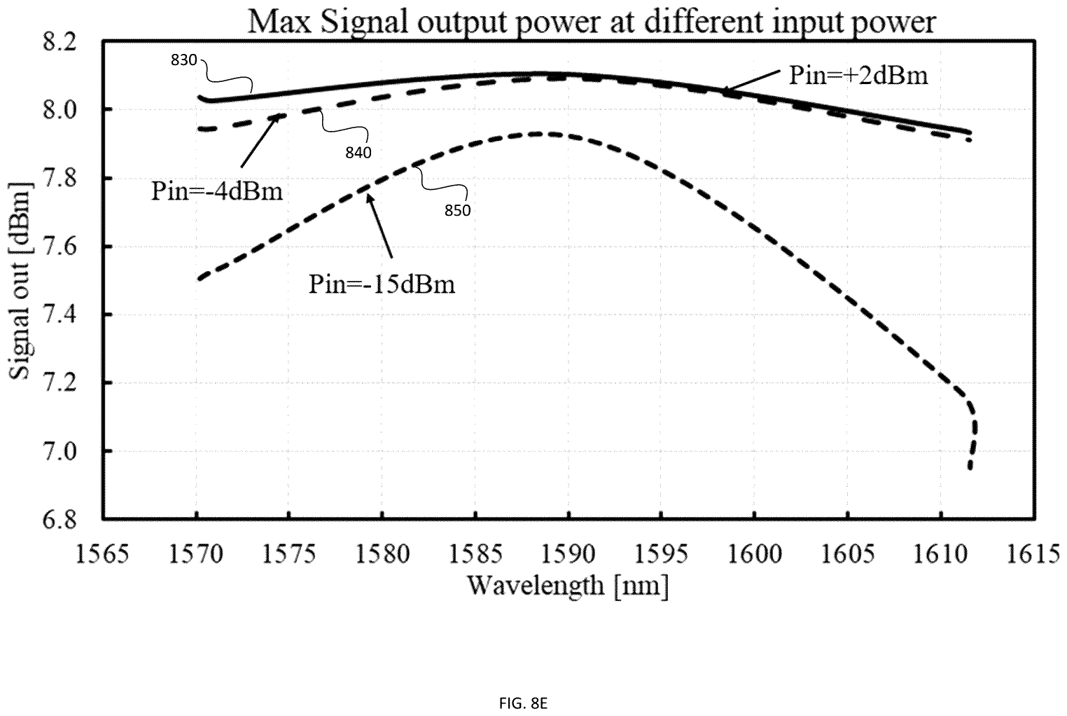

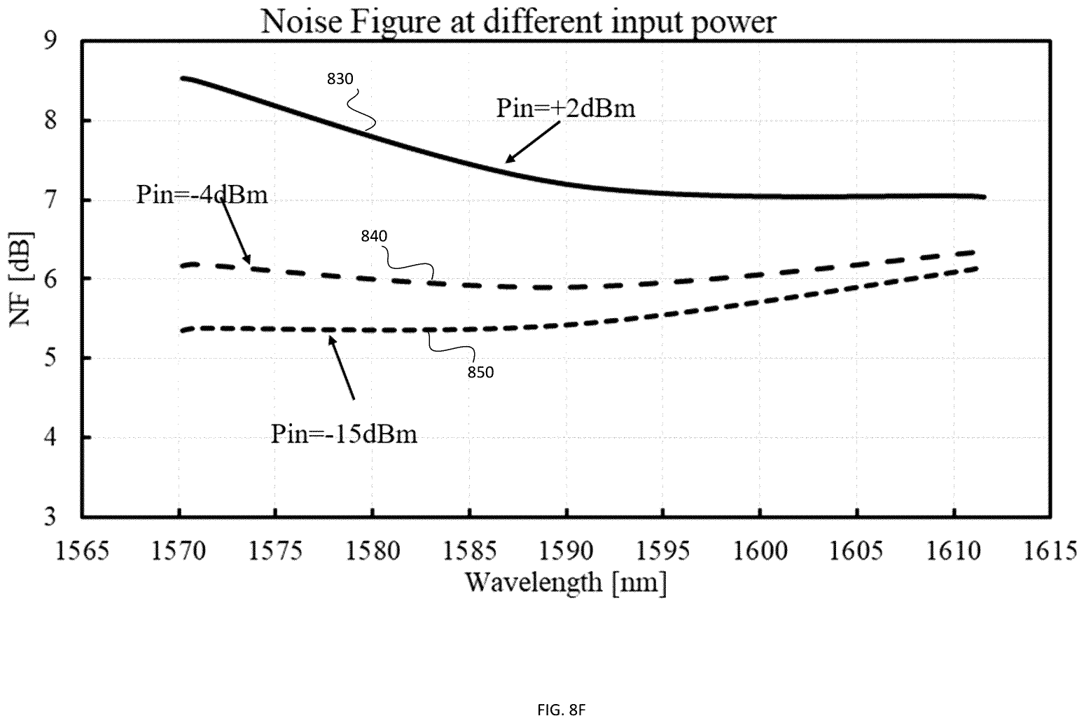

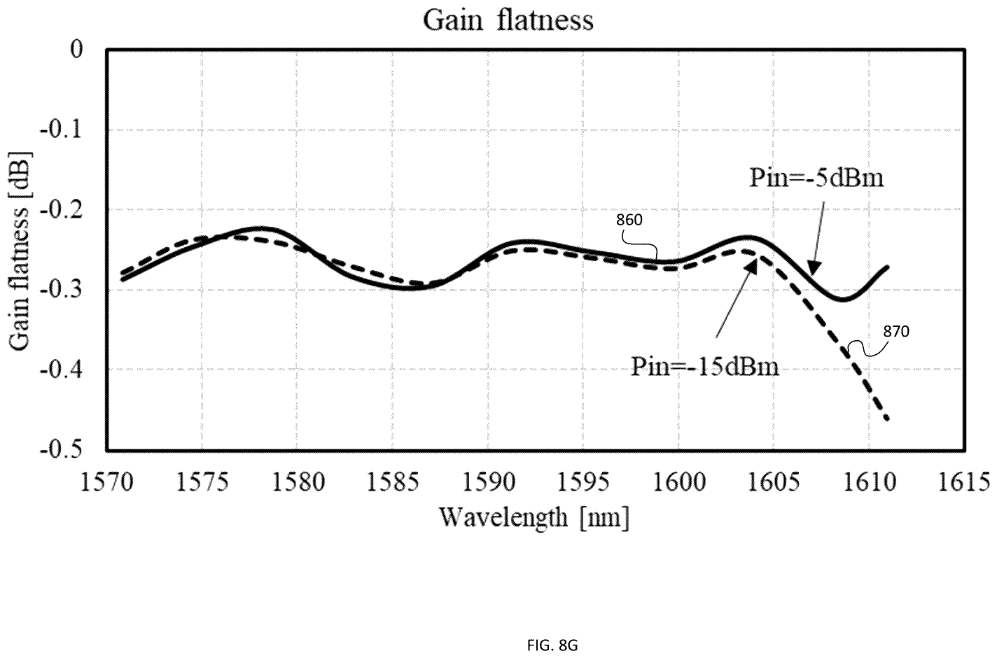

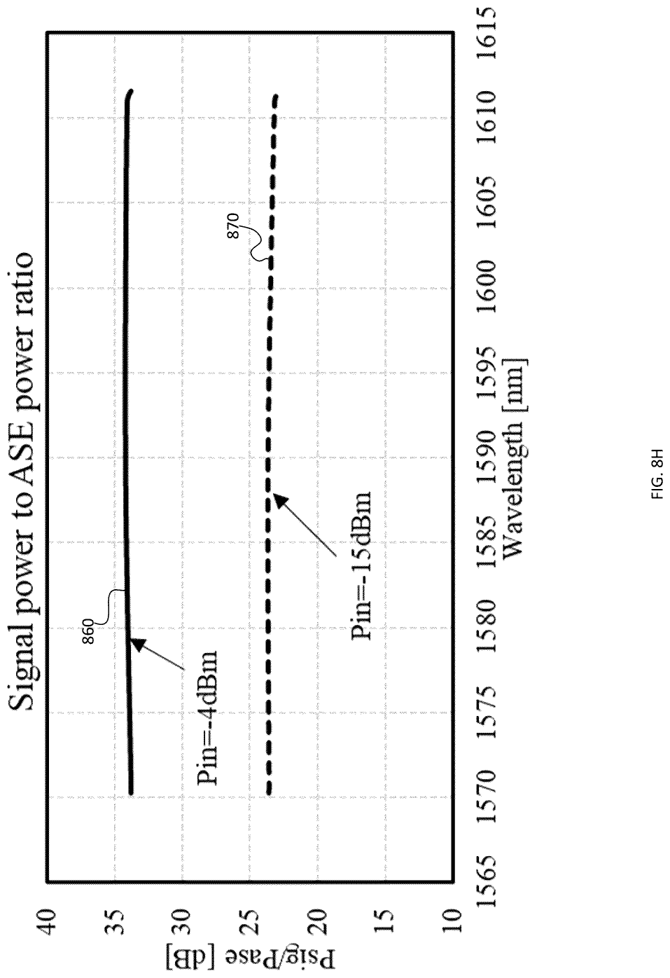

FIG. 8A shows an exemplary absorption of erbium-doped fiber as a function of wavelength. In FIG. 8A, there is shown an x-axis showing wavelength of light in nanometers, and a y-axis showing absorption/attenuation per meter of length of erbium-doped fiber as may be used in the patent. A solid line may illustrate a super high absorption EDF 810. A dashed line may show a normal high absorption EDF 820. As shown, the EDF 810 may exhibit significantly higher absorption anywhere in the illustrated range of wavelengths. The difference between EDF 810 and EDF 820 may, for example, be largest at approximately 978 nm. Erbium doped fiber amplifiers are widely used in optical communications. To reduce the length of the fiber required, super high absorption erbium fiber with smaller diameter may be used, for example such as EDF 810.

FIG. 8B shows an exemplary absorption of erbium-doped fiber as a function of wavelength. The same reference numbers refer to similar elements in other figures. FIG. 8B is similar to FIG. 8A, but illustrated erbium doped fiber with different absorption at different wavelengths compared to FIG. 8A, namely between 1450 nm and 1650 nm. As may be seen from FIG. 8B, the EDF 810 may exhibit larger absorption than EDF 820 throughout the illustrated frequency range, although the difference may be small at the high frequencies.

FIG. 8C shows an exemplary emission of erbium-doped fiber as a function of wavelength. The same reference numbers may refer to similar elements in other figures. FIG. 8C shows emission of EDF 810 compared to EDF 820 in the wavelength range between 1450 nm and 1650 nm. EDF 810 may exhibit a maximum of approximately 50 dB/m at a wavelength of approximately 1530 nm, compared to EDF 820 exhibiting about an emission of 25 db/m at the same wavelength. As may be seen from the figure, at 1600 nm the difference may be only about 3 dB/m between EDF 810 and EDF 820. At wavelengths exceeding approximately 1630 nm, EDF 810 may emit even less than EDF 820.

FIG. 8D illustrates total output power of a pluggable L-band amplifier. FIG. 8D may illustrate the output power of a pluggable L-band fiber amplifier in accordance with the patent. FIG. 10 may illustrate output power on the y-axis and wavelength on the x-axis. There is shown an input power 2 dBm curve 830, an input power −4 dBm curve 840, and an input power −15 dBm curve 850. When the input power is low, i.e. input power 850, it may be observed that the output power reduces significantly with increasing wavelength. The output power may be measured before MTOF.

FIG. 8E illustrates total signal output power of a pluggable L-band amplifier. The same reference numbers may refer to similar elements as shown in other figures. FIG. 8E may illustrate the signal output power that may result from MTOF filtering at different input powers. FIG. 8E may illustrate the signal output power through TOF and VOA, for example as may be observed at the output path diagram of FIG. 5, with VOA 545 set to 0. Compared to FIG. 8D, FIG. 8E may illustrate the signal without ASE filtering outside the signal bandwidth. When the input power is −4 dBm (840) and 2 dBm (830), the output signal power may reach 7.8 dBm within the L-band bandwidth, and when the input signal is −15 dBm (850), the output signal power may reach more than 7 dBm in the L-band bandwidth.

FIG. 8F illustrates a noise figure of a pluggable L-band amplifier. FIG. 8F illustrates a noise figure on the y-axis as a function of wavelength on the x-axis for different input powers. Same reference numbers may refer to similar elements in other figures. The noise figure of a pluggable L-band optical amplifier may be illustrated for different input powers when the fixed output signal power is 8 dBm at 1590 nm. When the input power is −15 dBm (850), the noise figure in the L-band bandwidth may be better for shorter wavelengths. The noise figure may be about 6.1 dB at 1611 nm; when the input power is −4 dBm (840), the noise figure in the L-band bandwidth may be relatively flat, about 6.2 dB at 1611 nm. When the input power is 2 dBm (830), the noise figure in the L-band bandwidth may be elevated for short wavelengths. The maximum noise figure illustrated for curve 830 may be about 8.6 dB at 1569 nm, and the minimum illustrated is about 7 dB at 1611 nm.

FIG. 8G illustrates a gain flatness for a pluggable L-band amplifier. FIG. 8F may illustrate gain flatness in dB on the y-axis as a function of wavelength in nm on the x-axis. There is shown an input power −5 dBm at curve 860 and −15 dBm at dashed curve 870. As shown in FIG. 8G, when a fixed output signal power is 8 dBm at wavelength 1590 nm, the gain may be quite flat for different wavelengths, for typical input power of −5 dBm within 0.31 dBm, and at an input power of −15 dBm within 0.5 dBm.

FIG. 8H illustrates a signal power to ASE power ratio for a pluggable L-band amplifier. FIG. 8H illustrates the power ratio on the y-axis as a function of the wavelength on the x-axis. The same reference numbers refer to similar elements in other figures. FIG. 8H illustrates that the when the fixed output signal power is 8 dBm at 1590 nm, the signal power to ASE power ratio is about 24 dB when the input power is −15 dBm (870); At −4 dBm (860), the signal power to ASE power ratio is around 34 dB. For both input powers, the curves 860 and 870 are essentially flat, illustrating consistent performance as a function of wavelength.

The present disclosure includes reference to certain examples; however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. An optical L-band amplifier device, said amplifier device comprising:
a pluggable housing;
a two-stage fiber amplification optical path, comprising ultra-high absorption fiber;
an IWDM; and
a plurality of fiber couplings, each protected by a coating.

2. The device of claim 1, wherein said pluggable housing is a multi-source agreement (MSA) compliant housing.

3. The device of claim 2, wherein said MSA compliant housing is an OSFP, QSFP-DD, QSFP-like, QSFP+, or QSFP28 4X housing.

4. The device of claim 1, wherein said two-stage fiber amplification optical path comprises two erbium-doped fiber coils.

5. The device of claim 1, wherein said ultra-high absorption fiber comprises 135 micrometer diameter erbium-doped fiber.

6. The device of claim 1, wherein said ultra-high absorption fiber comprises 80 micrometer cladding diameter erbium-doped fiber.

7. The device of claim 1, wherein said ultra-high absorption fiber comprises erbium-doped fiber with absorption of greater than 40 dB per meter at a wavelength of 1530 nm.

8. The device of claim 1, wherein said IWDM provides two isolators and two WDMs in a single component.

9. The device of claim 1, wherein said coating is applied using glue and heat.

10. The device of claim 9, wherein said coatings may withstand 150 kpsi proof tests.

11. The device of claim 1, wherein said optical L-band amplifier device comprises a pump.

12. The device of claim 11, wherein said pump may be uncooled.

13. The device of claim 12, wherein said pump comprises a Bragg grating design.
